(19) United States
(12) Patent Application Publication
(10) Pub. No.: US 2026/0131388 A1
(43) Pub. Date: May 14, 2026

(54) RECIPROCATING CUTTING TOOL

(71) Applicant: MAKITA CORPORATION, Anjo-shi (JP)

(72) Inventors: Norito CHIKUSA, Anjo-shi (JP); Wataru OGASAWARA, Anjo-shi (JP)

(73) Assignee: MAKITA CORPORATION, Anjo-shi (JP)

(21) Appl. No.: 19/331,652

(22) Filed: Sep. 17, 2025

(30) Foreign Application Priority Data
Nov. 11, 2024 (JP) 2024-196914

(51) Int. Cl. B23D 49/00; B23D 49/16; B23D 51/10

(52) U.S. Cl. CPC B23D 49/007; B23D 49/165; B23D 51/10

(57) ABSTRACT

A reciprocating cutting tool includes a blade attachment to which a blade is detachably attachable. The blade attachment is reciprocable. The blade attachment includes a first pressing member movable toward or away from the blade to press the blade, a first urging member that urges the first pressing member, a second pressing member that can press the blade in a direction different from a direction in which the first pressing member presses the blade, and a second urging member that urges the second pressing member. The first pressing member automatically presses the blade when the second pressing member is pushed by the blade. The first urging member is located to avoid being in a moving direction of the first pressing member.

### CROSS-REFERENCE TO RELATED APPLICATIONS

This application claims the benefit of priority to Japanese Patent Application No. 2024-196914, filed on November 11, 2024, the entire contents of which are hereby incorporated by reference.

### BACKGROUND

### 1. Technical Field

The disclosure relates to a reciprocating cutting tool such as a jigsaw or a reciprocating saw.

### 2. Description of the Background

A known jigsaw is described in Japanese Unexamined Patent Application Publication No. 2002-254403 (Patent Literature 1).

A jigsaw 10 in Patent Literature 1 includes a clamp 26 for a blade 22. The clamp 26 includes a sleeve 33 that rotates to switch the blade 22 between an unlocked state and a locked state. The sleeve 33 is urged in a rotation direction by a coil spring 44. In the locked state, the clamp 26 holds the blade 22 between a pin 42 pushed by a cam 33c in the sleeve 33 and a wall surface 37j of a slit 37a in a rod 37. The coil spring 44 is located radially outward from the pin 42 that presses the blade 22.

To attach or detach the blade 22, the user handles the blade 22 while maintaining the unlocked state by retaining the sleeve 33 at a rotational position through a continuous opening operation on an operable member 52.

A known blade attaching device for a jigsaw is described in Japanese Unexamined Patent Application Publication No. 2011-255449 (Patent Literature 2).

A blade attaching device 10 in Patent Literature 2 includes a rod 11, a blade guide 12, a guide engagement member 20, a blade holder 13, an operable member 14, and a torsion spring 18. The blade guide 12 is cylindrical and held on the lower end of the rod 11 with a cylindrical guide support 15 between the blade guide 12 and the lower end of the rod 11. The guide engagement member 20 is located below the guide support 15. The blade holder 13 and the operable member 14 are each cylindrical. The blade holder 13 and the operable member 14 are joined to each other with the guide support 15 and the guide engagement member 20 accommodated radially inward from the blade holder 13 and the operable member 14. The torsion spring 18 is located between the operable member 14 and the guide engagement member 20. The torsion spring 18 urges the operable member 14 toward a blade attachment position in the rotation direction.

The blade guide 12 is accommodated in an inner hole of the rod 11 in a manner movable in the axial direction. The blade guide 12 is pushed deep inside in response to a push performed by a blade B received in a guide groove 12c on the blade guide 12. A pair of rotation locking edges 12a of the blade guide 12 are then pulled out of corresponding engagement grooves 13f on the blade holder 13. The operable member 14 then automatically rotates toward the blade attachment position under an urging force from the torsion spring 18. The blade B includes a pair of engagement ears Bb. Each engagement ear Bb is held vertically between a corresponding stopper groove 20a on the guide engagement member 20 and a corresponding cam 13e on the blade holder 13, which has rotated to the blade attachment position.

### BRIEF SUMMARY

In the clamp 26 in Patent Literature 1, the coil spring 44 is located radially outward from the pin 42 that presses the blade 22. The clamp 26 thus has a larger diameter. The user can view an area around the blade 22 less easily during operation due to the larger diameter. Further, the user is to maintain the opening operation on the operable member 52 in attaching or detaching the blade 22 in the clamp 26. This is laborious.

In the blade attaching device 10 in Patent Literature 2, the engagement ears Bb in the blade B are held vertically. The engagement ears Bb thus wear easily. This changes the angle at which the blade B is attached, thus affecting the workability.

One or more aspects of the disclosure are directed to a reciprocating cutting tool that allows easy attachment and detachment of a blade.

A first aspect of the disclosure provides a reciprocating cutting tool, including:

a blade attachment to which a blade is detachably attachable, the blade attachment being reciprocable, the blade attachment including

a first pressing member movable toward or away from the blade to press the blade,

a first urging member configured to urge the first pressing member,

a second pressing member configured to press the blade in a direction different from a direction in which the first pressing member presses the blade, and

a second urging member configured to urge the second pressing member,

wherein the first pressing member automatically presses the blade when the second pressing member is pushed by the blade, and

the first urging member is located to avoid being in a moving direction of the first pressing member.

A second aspect of the disclosure provides a reciprocating cutting tool, including:

a blade attachment to which a blade is detachably attachable, the blade attachment being reciprocable, the blade attachment including

a sleeve rotatable about a direction in which the blade attachment is reciprocable, the sleeve including a receiving portion,

a first pressing member located radially inward from the sleeve and movable in response to rotation of the sleeve, the first pressing member being movable toward or away from the blade to press the blade,

a first urging member located radially inward from the sleeve, the first urging member being configured to urge the first pressing member,

a second pressing member configured to press the blade in the direction in which the blade attachment is reciprocable, the second pressing member including

an engaging portion engageable with the receiving portion to stop rotation of the sleeve,

a pressing portion extending in the direction in which the blade attachment is reciprocable, and

a tongue integrally connecting the engaging portion and the pressing portion and extending in the direction in which the blade attachment is reciprocable, the tongue being offset from an imaginary centerline of the pressing portion in a direction perpendicular to the direction in which the blade attachment is reciprocable, and

a second urging member configured to urge the second pressing member,

wherein, when the pressing portion is pushed by the blade, the engaging portion moves out of the receiving portion.

The reciprocating cutting tool according to the above aspects of the disclosure allows easy attachment and detachment of a blade.

### BRIEF DESCRIPTION OF DRAWINGS

FIG. 1 is a perspective view of a jigsaw according to an embodiment, showing its front surface, upper surface, and left surface.

FIG. 2 is a longitudinal central sectional view of the jigsaw in FIG. 1.

FIG. 3 is a sectional view taken along line A-A in FIG. 2.

FIG. 4 is an exploded perspective view of a blade, a blade holder, and a slider body in the jigsaw according to the embodiment, showing their upper surfaces, front surfaces, and left surfaces.

FIG. 5 is an exploded perspective view of the blade, the blade holder, and the slider body in the jigsaw according to the embodiment, showing their lower surfaces, rear surfaces, and right surfaces.

FIG. 6 is a perspective view of a sleeve in the blade holder in the embodiment, showing a rear half of the sleeve when the blade is locked.

FIG. 7A is a bottom view of the blade holder before insertion of the blade.

FIG. 7B is a bottom view of the blade holder with the blade being locked.

FIG. 8A is a sectional view of the blade holder taken along line A-A before and during insertion of the blade.

FIG. 8B is a sectional view taken along line C-C in FIG. 8A.

FIG. 9A is a sectional view of the blade holder taken along line A-A during pushing of the blade.

FIG. 9B is a sectional view taken along line D-D in FIG. 9A.

FIG. 10A is a sectional view of the blade holder taken along line A-A when the blade is locked.

FIG. 10B is a sectional view taken along line E-E in FIG. 10A.

FIG. 11A is a sectional view taken along line F-F in FIG. 8B.

FIG. 11B is a sectional view taken along line G-G in FIG. 9B.

FIG. 11C is a sectional view taken along line H-H in FIG. 10B.

### DETAILED DESCRIPTION

Embodiments of the disclosure will now be described with reference to the drawings as appropriate. In the embodiments described below, modifications are also described. The disclosure is not limited to the embodiments and the modifications.

The directional terms such as front, rear, up, down, right, and left in the embodiments and the modifications are defined for ease of explanation, and may be changed based on, for example, at least the operating situations or the movement of a component.

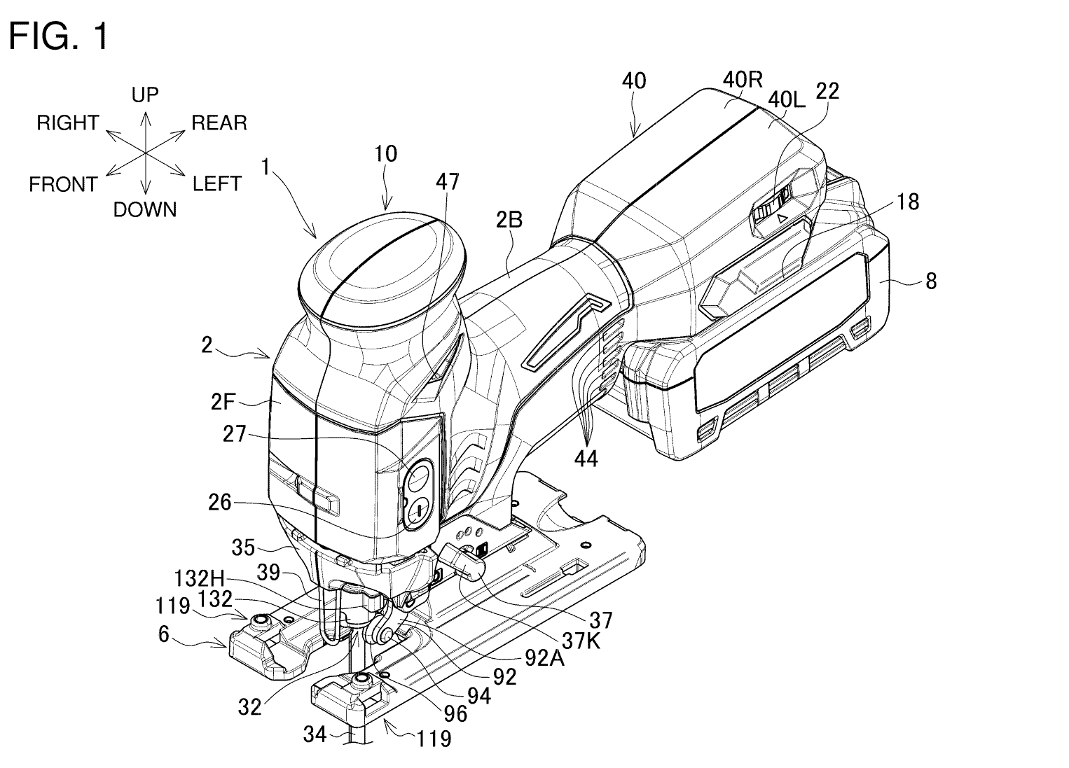

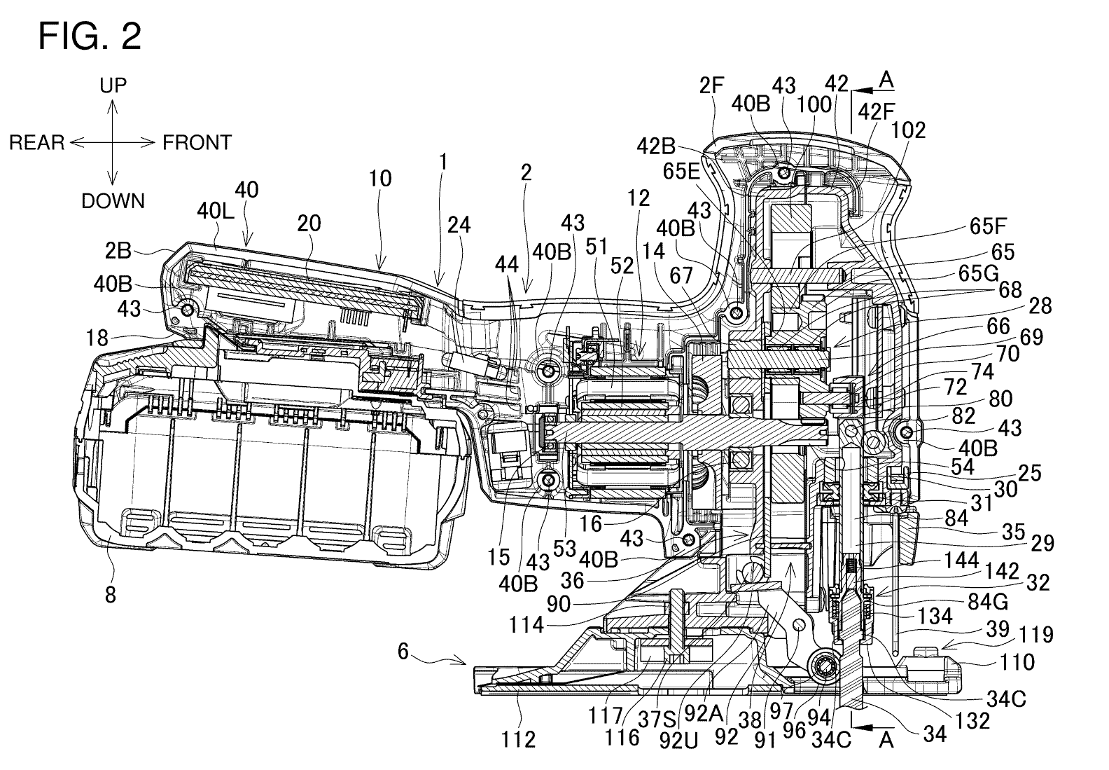

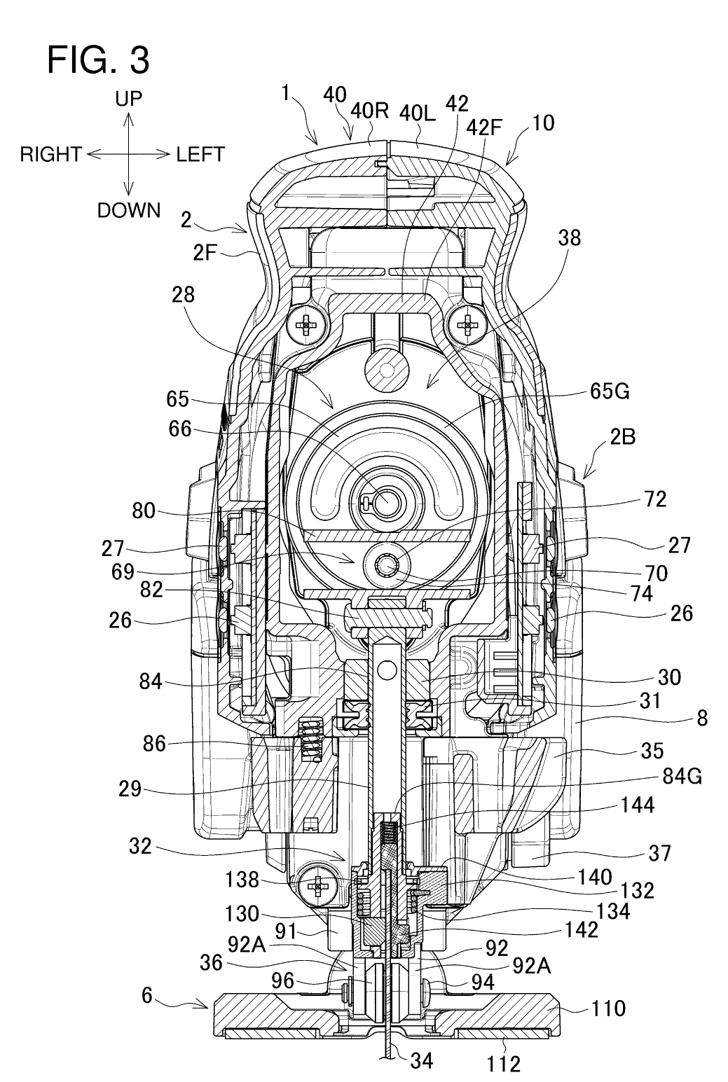

FIG. 1 is a perspective view of a jigsaw 1 as an example reciprocating cutting tool according to an embodiment, showing its front surface, upper surface, and left surface. FIG. 2 is a longitudinal central sectional view of the jigsaw 1. FIG. 3 is a sectional view taken along line A-A in FIG. 2.

The jigsaw 1 includes a body 2, a base unit 6, and a rechargeable battery 8. The jigsaw 1 is rechargeable and driven with the battery 8. The battery 8 is for power tools. The battery 8 may be a component of the body 2. The battery 8 may be independent of the jigsaw 1. The battery 8 may be a primary battery. The battery 8 may be any battery, such as a general-purpose battery, other than the battery for power tools. The battery 8 may be replaced with a power cord connectable to a power supply. A jigsaw including a power cord connectable to an alternating current (AC) power supply is an AC-powered jigsaw.

In FIG. 2, the front of the jigsaw 1 is on the right, and an upper portion of the jigsaw 1 is at the top. FIGS. 1 to 3 show the jigsaw 1 with a blade being locked.

The body 2 is substantially L-shaped as viewed from the left to the right. The body 2 includes a body front portion 2F at the front. The body front portion 2F extends vertically. The body 2 includes a body rear portion 2B at the rear. The body rear portion 2B extends rearward from the lower rear of the body front portion 2F. The body rear portion 2B is barrel-shaped.

The body 2 includes a housing 10, an electric motor 12, a fan 14, a rear bearing 15, a front bearing 16, a battery mount 18, a controller 20, a speed adjustment switch 22, a body connector 24, a switch unit 25, multiple (two) on-off switches 26, multiple (two) lock-off switches 27, a power transmitter 28, a slider 29 as an output unit, a slider guide 30, a dust seal 31, a blade holder 32 as a blade attachment, a blade 34 as a tip tool, a tool opener 35, an orbital unit 36, an orbital switcher 37, a counterweight unit 38, and a guard 39.

The body 2 includes, mainly in its internal space, the battery mount 18, the controller 20, the body connector 24, the rear bearing 15, the electric motor 12, the fan 14, the front bearing 16, the power transmitter 28, the orbital unit 36, the counterweight unit 38, the slider 29, the blade holder 32, the switch unit 25, the guard 39, and the tool opener 35 in substantially the stated order from the rear.

The arrangement of various components and portions may be modified variously. The blade 34 may be independent of the body 2 or the jigsaw 1, rather than being a component of the body 2 or the jigsaw 1. The slider 29 may be a component of the power transmitter 28, and the blade holder 32 may serve as the output unit. The slider 29 and the blade holder 32 may together serve as the output unit. A handle may be included to form a loop together with the body 2.

The housing 10 defines an outer wall of the body 2.

The housing 10 holds the components directly or indirectly.

The housing 10 includes a main housing 40 and a gear housing 42.

The main housing 40 is formed from plastic. The main housing 40 is halved into a left main housing 40L and a right main housing 40R.

The left main housing 40L includes multiple screw bosses 40B. The right main housing 40R includes multiple threaded hole portions. The threaded hole portions have threaded holes corresponding to the screw bosses 40B. The left main housing 40L and the right main housing 40R are joined together with screws 43 placed in the threaded hole portions and the screw bosses 40B.

The main housing 40 is L-shaped as viewed from the right to the left. The main housing 40 includes an upper portion grippable by a user. The main housing 40 includes a lower rear portion having a lower rear opening. The main housing 40 includes a lower front portion having a lower front opening.

The main housing 40 has multiple inlets 44 and multiple outlets 47.

The inlets 44 are elongated in the front-rear direction. Some of the inlets 44 are arranged vertically in a middle portion of the left main housing 40L in the front-rear direction. The other inlets 44 are arranged vertically in a middle portion of the right main housing 40R in the front-rear direction.

The outlets 47 are elongated in the front-rear direction. Some of the outlets 47 are arranged in an upper portion of the left main housing 40L. The other outlets 47 are arranged in an upper portion of the right main housing 40R.

Air drawn in through the inlets 44 under negative pressure generated by the rotating fan 14 cools the electric motor 12. Most of the air that has cooled the electric motor 12 is discharged as a blower to a space defined by a branched portion of a base 110. The rest of the air that has cooled the electric motor 12 is discharged through the outlets 47.

The gear housing 42 is formed from an aluminum die-cast alloy. The gear housing 42 is bell-shaped and has an opening in its lower end. The gear housing 42 is halved into a front gear housing 42F and a rear gear housing 42B.

The front gear housing 42F includes threaded hole portions in its upper right portion, lower right portion, and upper left portion. The rear gear housing 42B includes screw bosses corresponding to the threaded hole portions. The front gear housing 42F and the rear gear housing 42B are joined together with screws placed in the threaded hole portions and the screw bosses.

The gear housing 42 is held by the main housing 40. The gear housing 42 holds the power transmitter 28, the orbital unit 36, the counterweight unit 38, the slider 29, and the blade holder 32 directly or indirectly. The gear housing 42 includes a lower rear portion exposed downward through the lower front opening of the main housing 40.

The gear housing 42 has a rear surface having an upper hole, an upper opening, and a middle opening.

The housing 10 may be modified variously. For example, an outer wall of the body front portion 2F and an outer wall of the body rear portion 2B in the main housing 40 may be separate and may be joined together. The left main housing 40L and the right main housing 40R in the halved main housing 40 may be largely different from each other in at least one of the size or the shape. The left main housing 40L and the right main housing 40R may be joined together with fasteners other than the screws, using, for example, an engaging portion such as a tab and a receiving portion such as a tab hole. The gear housing 42 may or may not be divided into the front and rear gear housings, and may be a single unit. The main housing 40 and the gear housing 42 may be integral with each other. At least any of the materials of the components of the housing 10 or the number and arrangement of openings in the housing 10 may be modified. At least one of the number or the arrangement of the outlets 47 may be modified as appropriate.

The electric motor 12 is a direct current (DC) brushless motor. The electric motor 12 is held in the main housing 40. The main housing 40 can serve as a motor housing to hold the electric motor 12.

The electric motor 12 includes a stator 51 and a rotor 52.

The stator 51 is cylindrical. The stator 51 is held in the main housing 40 with its imaginary central axis extending in the front-rear direction.

The rotor 52 includes a motor shaft 53 extending in the front-rear direction. The rotor 52 is cylindrical and has a center through which the motor shaft 53 extends. The rotor 52 is located radially inward from the stator 51.

The rotor 52 rotates about the motor shaft 53.

The motor shaft 53 receives a pinion 54 on its front end.

The fan 14 is integrally fixed to the motor shaft 53.

The fan 14 is a centrifugal fan. The fan 14 may be any other fan such as an axial flow fan.

The main housing 40 has a lower opening with the rear of the opening located radially outward from the fan 14.

The rear bearing 15 is a ball bearing. The rear bearing 15 supports the motor shaft 53 in a rotatable manner. The rear bearing 15 is located between the electric motor 12 and the controller 20. The rear bearing 15 includes an outer ring held by the main housing 40.

The front bearing 16 is a ball bearing. The front bearing 16 supports the motor shaft 53 in a rotatable manner. The front bearing 16 is located between the fan 14 and the pinion 54. The front bearing 16 is located in front of the fan 14. The front bearing 16 includes an outer ring held in the middle opening in the gear housing 42.

At least one of the rear bearing 15 or the front bearing 16 may be a bearing of another type. For example, the rear bearing 15 may be a needle bearing. Other bearings may also be of any type.

The battery mount 18 is located at the rear end of the body 2.

The battery 8 is attachable to the battery mount 18. The battery mount 18 includes a body terminal connectable to a terminal on the battery 8. The body terminal is received in the lower rear opening in the main housing 40.

The battery 8 is attached to a lower portion of the battery mount 18. With the terminal on the battery 8 facing upward, the battery 8 is slid forward from the rear of the battery mount 18 for attachment. The sliding direction of the battery 8 for attachment may be a direction other than from the rear to the front. The battery 8 may be attached in a manner other than sliding.

The battery 8 is a lithium-ion battery of 36 V (volt). The battery 8 includes eight cells (not shown) in a plastic battery case. The cells are axially elongated cylinders, and extend laterally when the battery 8 is attached. The battery 8 has power for driving the electric motor 12. The battery 8 may be any lithium-ion battery with a voltage of, for example, 10.8, 14.4, 18, 25.2, or 28 V. The battery 8 may be a lithium-ion battery with a voltage of less than 10.8 V or more than 36 V. The battery 8 may be another type of battery. Multiple batteries 8 may be used.

The controller 20 is held above the battery mount 18.

The controller 20 controls the electric motor 12. The controller 20 is electrically connected to the electric motor 12. The electric motor 12 is electrically connected to the body terminal on the battery mount 18 with the body connector 24.

The controller 20 is electrically connected to the speed adjustment switch 22, the switch unit 25, the on-off switches 26, and the lock-off switches 27.

The speed adjustment switch 22 is a dial switch. The speed adjustment switch 22 includes a disk extending in the front-rear and lateral directions. The disk is rotatable about its imaginary central axis extending vertically. The disk includes a left portion exposed through a hole in the left surface of the main housing 40. The user rotates the disk by directing the left portion of the disk forward or rearward. The speed adjustment switch 22 outputs a signal corresponding to the amount of rotation of the disk. The output signal is transmitted to the controller 20.

The speed adjustment switch 22 may be eliminated.

The body connector 24 is connected to a lead wire (not shown) connecting the controller 20 and the body terminal on the battery mount 18.

The body connector 24 is separable in a reconnectable manner. When the electric motor 12 is replaced due to, for example, a failure, the electric motor 12 can be easily replaced by separating the body connector 24. In this case, the controller 20 connected to the electric motor 12 is also replaced at the same time.

The body connector 24 may be eliminated.

The switch unit 25 is located above the guard 39 in the body 2. The switch unit 25 is held in the housing 10.

The switch unit 25 includes a light (not shown). The light is, for example, a light-emitting diode (LED). The light illuminates a target portion of a workpiece cut by the blade 34 and an area around the target portion. The light is turned on or off in response to switching of the lock-off switches 27. The light is turned on when the lock-off switches 27 are turned on. The light is turned off when a predetermined time elapses after the on-off switches 26 are turned off. The light is immediately turned off when the lock-off switches 27 are turned off.

The light is controlled by the controller 20. The switch unit 25 is connected to the controller 20 with a lead wire (not shown).

The light may be eliminated. The light may be separate from the switch unit 25. The light may be turned on or off in a manner other than the manner described above. For example, the light may be turned on or off by a dedicated light switch.

The on-off switches 26 are tactile switches. The left on-off switch 26 is held on a left front portion of the main housing 40. The right on-off switch 26 is held on a right front portion of the main housing 40.

The on-off switches 26 alternately transmit an on-signal and an off-signal to the controller 20 every time the on-off switches 26 are pushed by the user.

The lock-off switches 27 are tactile switches. The left lock-off switch 27 is located on the left front portion of the main housing 40 and above the corresponding on-off switch 26. The right lock-off switch 27 is located on the right front portion of the main housing 40 and above the corresponding on-off switch 26.

The lock-off switches 27 alternately transmit an on-signal and an off-signal to the controller 20 every time the lock-off switches 27 are pushed by the user.

At least the on-off switches 26 or the lock-off switches 27 may be of any type. For example, the on-off switches 26 may be toggle switches rather than the tact switches. Other switches may also be of any type.

In response to receiving an on-signal from the lock-off switches 27, the controller 20 activates a timer to determine whether the predetermined time has elapsed. When the controller 20 receives, after receiving the on-signal, an on-signal from the on-off switches 26 before the predetermined time elapses, the controller 20 turns on the power supply of the jigsaw 1 and drives the electric motor 12. The controller 20 controls the rotational speed of the electric motor 12 based on the signal corresponding to the amount of rotation of the disk received from the speed adjustment switch 22.

When the controller 20 receives an on-signal from the on-off switches 26 with the jigsaw 1 being on, the controller 20 turns off the power supply of the jigsaw 1 and stops the electric motor 12. When the lock-off switches 27 are turned off with the jigsaw 1 being on, the electric motor 12 is stopped and the light is turned off.

The controller 20 may control, for example, the power supply of the jigsaw 1 in any manner other than the manner described above. Other control may also be performed differently.

The power transmitter 28 transmits power from the electric motor 12 to the blade 34 through the slider 29 and the blade holder 32. The slider 29 is a rectangular prism. The slider 29 extends vertically. The blade holder 32 is held by a lower end portion of the slider 29. The slider 29 can reciprocate in the vertical direction. The blade holder 32 can reciprocate in the vertical direction.

The power transmitter 28 includes an intermediate gear 65, a support shaft 66, a spacer 67, multiple (two) needle bearings 68, and a guide roller unit 69.

The intermediate gear 65 includes a gear 65G, a first cam 65E, and a second cam 65F. The intermediate gear 65 is cylindrical and extends vertically. The intermediate gear 65 reduces the rotation of the motor shaft 53 and transmits the rotation to the slider 29.

The gear 65G is located in a front portion of the intermediate gear 65. The gear 65G has multiple teeth on its outer curved surface. The gear 65G has a larger outer diameter than a rear portion of the intermediate gear 65. The gear 65G meshes with the pinion 54.

The first cam 65E is located in the rear portion of the intermediate gear 65. The first cam 65E has a cylindrical outer surface decentered from an imaginary central axis of the intermediate gear 65 extending in the front-rear direction.

The second cam 65F is located in a middle portion of the intermediate gear 65. The second cam 65F has a cylindrical outer surface decentered from the imaginary central axis of the intermediate gear 65 extending in the front-rear direction.

The support shaft 66 is cylindrical and extends in the front-rear direction.

The support shaft 66 includes a rear portion fixed to the upper opening of the gear housing 42 with the cylindrical spacer 67 between the rear portion of the support shaft 66 and the gear housing 42. The support shaft 66 protrudes frontward from the rear inner surface of the gear housing 42.

Each needle bearing 68 surrounds a middle portion of the support shaft 66. The two needle bearings 68 are arranged in the front-rear direction.

Each needle bearing 68 supports the intermediate gear 65 in a manner rotatable about an imaginary central axis of the intermediate gear 65.

The needle bearings 68 and the support shaft 66 are located radially inward from the intermediate gear 65.

The guide roller unit 69 includes a shaft 70, a needle bearing 72, and a guide roller 74.

The shaft 70 is cylindrical. The shaft 70 extends in the front-rear direction. The shaft 70 includes a rear portion fixed to the gear 65G. The shaft 70 is decentered from the gear 65G. The shaft 70 protrudes frontward from the front surface of the gear 65G.

The needle bearing 72 is supported on a front portion of the shaft 70.

The guide roller 74 is cylindrical. The guide roller 74 is supported on the needle bearing 72 in a manner rotatable about an imaginary central axis extending in the front-rear direction. The guide roller 74 is located in front of the gear 65G.

The slider 29 extends vertically and is movable vertically.

The slider 29 includes a roller guide 80, a shaft 82, and a slider body 84.

The roller guide 80 extends laterally. The roller guide 80 has a groove extending laterally. The roller guide 80 receives the guide roller 74 in the groove to allow lateral movement of the guide roller 74.

The shaft 82 is cylindrical and extends laterally.

The slider body 84 is a rectangular prism extending vertically. The slider body 84 is attached to the roller guide 80 with the shaft 82 between the slider body 84 and the roller guide 80. The shaft 82 is placed through a lower end portion of the roller guide 80 and an upper end portion of the slider body 84. The slider body 84 is swingable back and forth about the shaft 82.

The guide roller 74 in the guide roller unit 69 decentered from the intermediate gear 65 moves laterally in the roller guide 80 in the slider 29 to allow vertical movement alone to be transmitted to the roller guide 80. The slider 29 thus reciprocates vertically as the intermediate gear 65 rotates. The guide roller 74 and the roller guide 80 convert a rotational force to reciprocating motion.

The slider guide 30 is cylindrical and extends vertically. The slider body 84 extends radially inward from the slider guide 30. The slider guide 30 guides the slider 29 that reciprocates. The slider guide 30 is held by the gear housing 42.

The dust seal 31 is annular and elastic. The dust seal 31 is held by the gear housing 42. The slider body 84 extends radially inward from an inner hole of the dust seal 31. The dust seal 31 is in contact with the slider 29, reducing entry of dust into the housing 10.

The blade holder 32 is held by the slider body 84. The blade holder 32 is connected to a lower end portion of the slider body 84. The blade 34 is attachable to and detachable from the blade holder 32.

The blade 34 extends vertically. The blade 34 includes a workpiece-acting part on one of its long edges. The workpiece-acting part acts on a workpiece. The workpiece-acting part is, for example, a saw blade that cuts a workpiece. The blade 34 has its upper end portion attached to the blade holder 32, with the workpiece-acting part facing frontward. The blade 34 is attached to the blade holder 32 without using any tool such as a wrench, or in other words, in a tool-less manner.

The blade holder 32 will be described in more detail later.

The tool opener 35 is a lever and extends laterally. The tool opener 35 is rotatable about an imaginary vertical axis located in its right end portion. The user can open the tool opener 35 by moving a left end portion of the tool opener 35 forward. The tool opener 35 is urged by a spring 86 as an elastic member in a rotation direction in which the left end portion of the tool opener 35 is pulled backward, or in other words, in a closing direction.

The blade holder 32 is adjacent to an inner portion of the left end portion of the tool opener 35 in the lateral direction.

The tool opener 35 is formed from a light-transmissive resin. The tool opener 35 transmits light from the light. The tool opener 35 may or may not be light-transmissive.

The orbital unit 36 includes a push plate 90, a holder shaft 91, a roller holder 92, a roller shaft 94, a back roller 96, and a needle bearing 97.

The push plate 90 extends vertically and laterally. The push plate 90 has a first cam hole in its upper portion. The first cam 65E is placed radially inward from the first cam hole. The first cam 65E moves the push plate 90 vertically through the inner surface of the first cam hole. The first cam 65E is decentered in opposite phase to the guide roller unit 69.

The holder shaft 91 is cylindrical and extends laterally.

The roller holder 92 is located below the push plate 90. The roller holder 92 includes an upper plate 92U and multiple (two) arms 92A. The upper plate 92U extends in the front-rear and lateral directions. Each arm 92A extends in the front-rear and vertical directions, and extends frontward and downward from the left or right edge of the upper plate 92U. The holder shaft 91 extends between middle portions of the arms 92A. The roller holder 92 is held by the gear housing 42 in a manner swingable about the holder shaft 91.

The roller shaft 94 is cylindrical and extends laterally. The roller shaft 94 extends between lower end portions of the arms 92A in the roller holder 92.

The back roller 96 is cylindrical and extends laterally. The back roller 96 is supported on the roller shaft 94 in a rotatable manner with the needle bearing 97 between them. The back roller 96 can be in contact with the rear edge of the blade 34 without interfering with reciprocation of the blade 34.

The orbital switcher 37 includes a shaft 37S and a knob 37K.

The shaft 37S extends laterally. The shaft 37S includes a center portion having a semicircular cross section as viewed from the right to the left. The center portion of the shaft 37S is semicylindrical. The shaft 37S is located above the upper plate 92U in the roller holder 92 in the orbital unit 36 and behind a lower end portion of the push plate 90.

The knob 37K is fixed to the left end of the shaft 37S. The knob 37K extends radially outward from the shaft 37S.

The user can operate the knob 37K to rotate the orbital switcher 37 about an imaginary central axis of the shaft 37S. The knob 37K is rotatable between marks 0 and III on the outer surface of the gear housing 42. One recess is located adjacent to the mark 0 and one recess is located adjacent to the mark III between these marks. Two recesses are arranged between the recess adjacent to the mark 0 and the recess adjacent to the mark III. The two recesses are adjacent to the recess adjacent to the mark III. In other words, three recesses are arranged adjacent to the mark III. Some or all of the recesses and the marks may be eliminated.

The user switches the mode of an orbital action of the blade 34 as appropriate by operating the knob 37K. The orbital action of the blade 34 is based on the front-rear swing of the back roller 96 in contact with the blade 34.

When the knob 37K is at a position of the mark 0, the semicylindrical portion of the shaft 37S is at a rotational position at which the semicylindrical portion has its curved surface facing downward and the semicylindrical portion is in contact with the upper plate 92U in the roller holder 92. In this case, the back roller 96 is at the same position without swinging, independently of the vertical position of the push plate 90 movable vertically by the first cam 65E. The blade 34 thus does not perform orbital action.

When the knob 37K is at a position away from the mark 0, the semicylindrical portion of the shaft 37S separates from the upper plate 92U in the roller holder 92. The push plate 90 moved vertically causes the roller holder 92 and the back roller 96 to swing with the upper plate 92U. The back roller 96 applies, to the blade 34, a force in the front-rear direction. This force causes the slider body 84, the blade holder 32, and the blade 34 to swing about the shaft 82. The blade 34 moving vertically receives the swinging action in the front-rear direction. This causes the blade 34 to perform orbital action along an imaginary ellipse as viewed from the right to the left. The semicylindrical portion of the shaft 37S gradually separates from the upper plate 92U as the knob 37K moves away from the mark 0. The amount of swing of the roller holder 92 and the back roller 96 changes based on the rotational position of the knob 37K. For example, when the knob 37K rotates to a rotational position of the mark III, the amount of swing of the roller holder 92 and the back roller 96 is maximum. The mode of the orbital action thus changes based on the rotational position of the knob 37K. The amount of orbital action is switchable among three different amounts by switching the position of the knob 37K to align with one of the three recesses or the positions of the marks described above.

The counterweight unit 38 includes a counterweight 100 and a shaft 102.

The counterweight 100 is a plate extending vertically and laterally. The counterweight 100 has a cam hole in its middle portion in the vertical direction and an upper hole above the cam hole. The cam hole in the counterweight 100 receives the second cam 65F on the intermediate gear 65. The second cam 65F is decentered in opposite phase to the guide roller unit 69.

The shaft 102 extends in the front-rear direction. The shaft 102 is held by the gear housing 42. The shaft 102 extends between a front wall and a rear wall of the gear housing 42. The shaft 102 includes a middle portion received in the upper hole in the counterweight 100.

The counterweight 100 is moved vertically in opposite phase to the slider 29, the blade holder 32, and the blade 34 by the second cam 65F decentered in opposite phase to the guide roller unit 69. The counterweight 100 thus reduces vibrations resulting from the reciprocation of the slider 29, the blade holder 32, and the blade 34.

The guard 39 extends vertically. The guard 39 has its upper end held by the gear housing 42. The guard 39 has its lower end adjacent to the upper surface of the base unit 6.

The blade 34 is located behind the guard 39.

The base unit 6 is located below the body 2 and attached to the body 2.

The base unit 6 includes the base 110, a base plate 112, multiple (four) screws (not shown), a nut 114, a bolt 116, and a holding plate 117.

The base 110 is formed from an aluminum die-cast alloy. The base 110 is a plate extending in the front-rear and lateral directions.

The base 110 includes the branched portion at the front. The blade 34 can pass through the space defined by the branched portion of the base 110.

The base 110 includes ruler mounts 119. The ruler mounts 119 are located at the front ends of the branched portion of the base 110. The ruler mounts 119 can receive a single ruler (not shown).

The base plate 112 is formed from a metal and is a steel plate. The base plate 112 is located in a lower surface portion of the base unit 6 to reduce wear of the base unit 6 caused by contact with a workpiece.

The base plate 112 is joined to a lower portion of the base 110 with four screws.

The nut 114 is held by the lower rear portion of the gear housing 42. The nut 114 is located at the middle of the body 2 in the lateral direction.

The nut 114 may be a component of the body 2 or may be independent of the body 2.

The bolt 116 extends vertically with its head facing downward.

The holding plate 117 is a plate. The holding plate 117 has an arch-shaped cross section. The holding plate 117 has a bolt hole in its middle portion. The holding plate 117 may be eliminated.

The bolt 116 is placed through the bolt hole in the holding plate 117 and a cross-shaped hole in the base 110, and is received in the nut 114.

The base unit 6 is fastened to the gear housing 42 with the bolt 116 received in the nut 114 and the holding plate 117.

The user changes, as appropriate, at least one of the orientation of the body 2 relative to the base unit 6 (the tilt angle of the body 2 to the left or right) or the position of the body 2 relative to the base unit 6 in the front-rear direction.

To change the orientation of the body 2 relative to the base unit 6, the user loosens the bolt 116. The base unit 6 fastened with the holding plate 117 is then unfastened, allowing the bolt 116 to move along the cross-shaped hole. The user moves the bolt 116 along a portion of the cross-shaped hole elongated in the lateral direction to change the orientation of the body 2 relative to the base unit 6. In other words, the user can change the tilt angle of the body 2 relative to the base unit 6. The user tightens the bolt 116 at an intended orientation to complete the operation of changing the orientation.

To change the position of the body 2 relative to the base unit 6 in the front-rear direction, the user loosens the bolt 116, moves the bolt 116 along a portion of the cross-shaped hole elongated in the front-rear direction, and tightens the bolt 116 at an intended position.

When the bolt 116 is at the intersection between the portion of the cross-shaped hole elongated in the front-rear direction and the portion of the cross-shaped hole elongated in the lateral direction, the body 2 is at a reference position relative to the base unit 6. FIGS. 1 to 3 show the jigsaw 1 with the body 2 at the reference position.

The blade holder 32 will now be described in more detail.

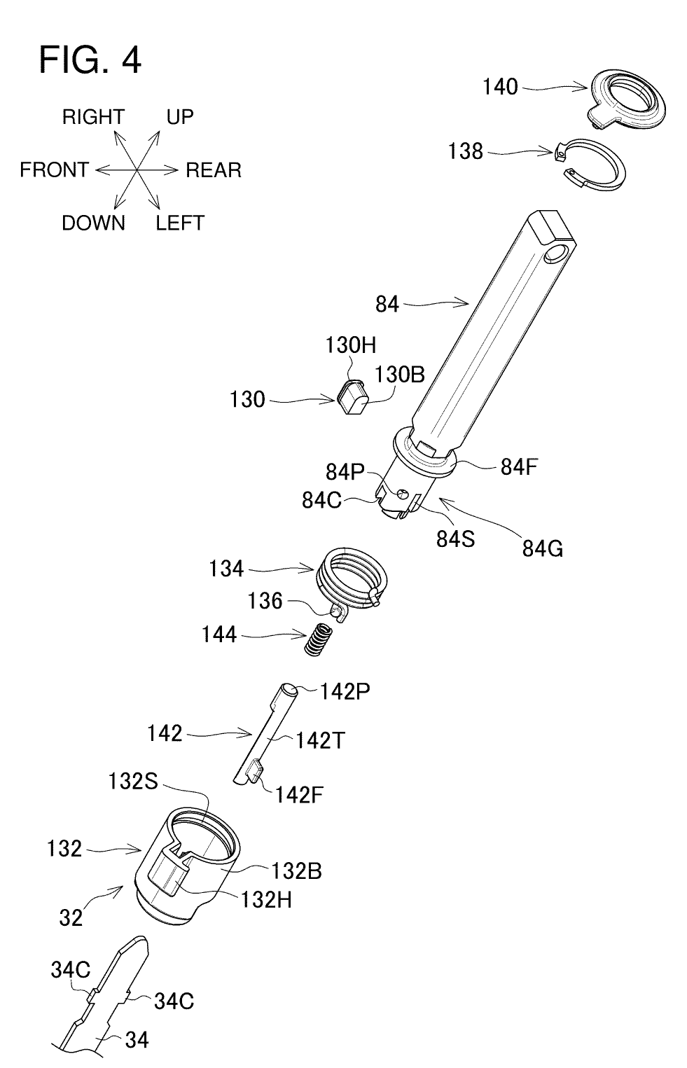

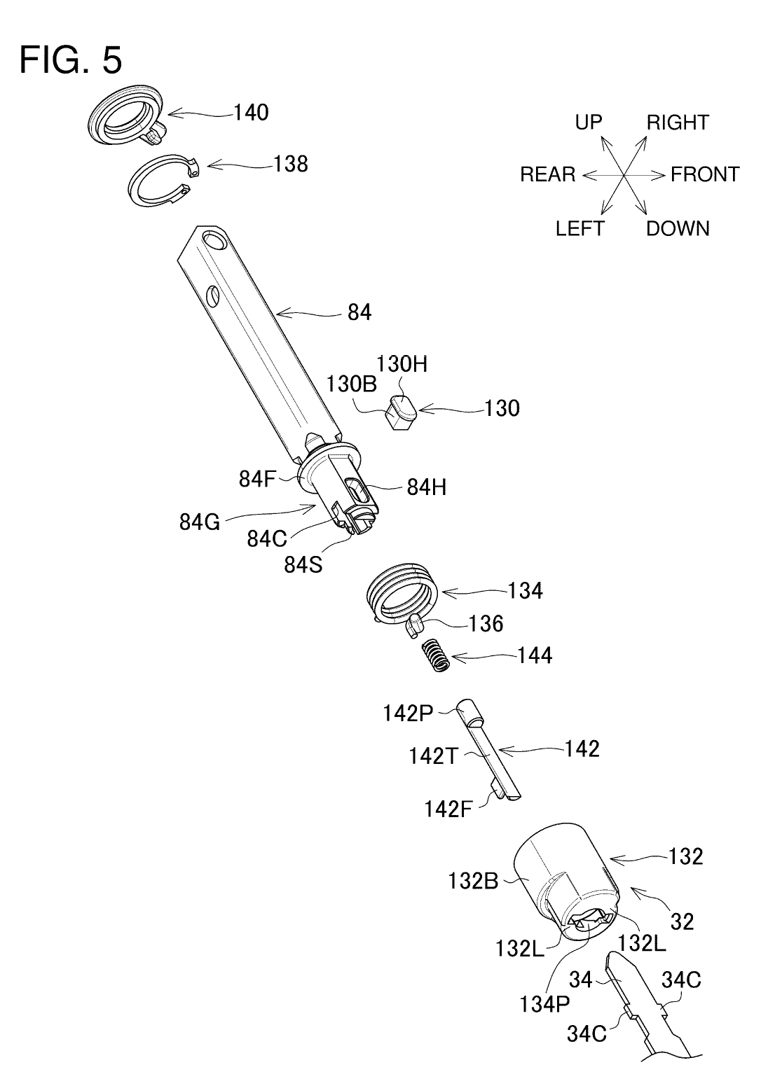

FIGS. 4 and 5 are each an exploded perspective view of the blade 34, the blade holder 32, and the slider body 84. In FIGS. 4 and 5, the blade is yet to be inserted.

The blade 34 includes multiple (two) protrusions 34C in its end portion adjacent to the body 2, or in other words, its upper end portion that is the end portion adjacent to the body. The protrusions 34C are arranged at the front and rear of the blade 34. The front protrusion 34C protrudes frontward from the front side of the upper end portion of the blade 34. The rear protrusion 34C protrudes rearward from the rear side of the upper end portion of the blade 34. With the protrusions 34C, the upper end portion of the blade 34 is cross-shaped.

The slider body 84 includes a guide 84G in its lower end portion that is an end portion opposite to an end portion adjacent to the body 2. The guide 84G is a cylindrical metal block having a groove, a slit, and a hole. The guide 84G is fixed to the lower end of a portion of the slider body 84 other than the guide 84G. The guide 84G may be integral with the portion of the slider body 84, which is a rectangular prism, other than the guide 84G.

The guide 84G includes a blade receiving groove 84C, a guide hole 84H, an engaging portion guide slit 84S, a stopper receiving hole 84P, and a flange 84F.

The blade receiving groove 84C is located in a middle portion of the guide 84G in the lateral direction. The blade receiving groove 84C extends in the front-rear and vertical directions. The blade receiving groove 84C includes a lower portion reaching the outer surface of the guide 84G in the front-rear direction. The lower portion of the blade receiving groove 84C serves as slits in the blade receiving groove 84C. The portion of the blade receiving groove 84C other than the slits is a hole combining a rectangular space and a semicylindrical space as viewed from bottom to top. The semicylindrical space is located on the left of the rectangular space. The hole of the blade receiving groove 84C has a semicylindrical left inner surface.

The guide hole 84H extends laterally. The guide hole 84H is located on the right of the blade receiving groove 84C and connects with the blade receiving groove 84C.

The engaging portion guide slit 84S is located on the left of the blade receiving groove 84C. The engaging portion guide slit 84S connects with the blade receiving groove 84C. The engaging portion guide slit 84S reaches the left outer surface of the guide 84G. The engaging portion guide slit 84S extends vertically.

The stopper receiving hole 84P is located between the blade receiving groove 84C and the engaging portion guide slit 84S in the circumferential direction. The stopper receiving hole 84P extends obliquely from the left front to the right rear. The stopper receiving hole 84P connects with the blade receiving groove 84C.

The flange 84F is located in an upper end portion of the guide 84G. The flange 84F protrudes radially outward from a portion adjacent to the flange 84F. The flange 84F is annular as viewed from bottom to top.

At least one of the groove, the slit, or the hole may be modified differently. For example, the engaging portion guide slit 84S may or may not reach the outer surface of the guide 84G. The stopper receiving hole 84P may or may not connect with the blade receiving groove 84C.

The blade holder 32 includes a first pressing member 130, a sleeve 132, a first urging member 134, a stopper 136, a circlip 138, a cover 140, a second pressing member 142, and a second urging member 144.

The first pressing member 130 is pin-shaped. The first pressing member 130 includes a first pressing member body 130B and a first pressing member head 130H.

The first pressing member body 130B is a prism extending laterally and is slidable into the guide hole 84H. The first pressing member 130 moves in the lateral direction. The first pressing member 130 is movable toward or away from the blade 34.

The first pressing member head 130H is located on the right of the first pressing member body 130B. The first pressing member head 130H extends farther than a right end portion of the first pressing member body 130B in the vertical and front-rear directions. This reduces the likelihood that the entire first pressing member 130 enters a portion of the guide hole 84H radially inward from an open portion located radially outward from the guide hole 84H.

The first pressing member 130 is located radially inward from the sleeve 132. The first pressing member 130 can press the blade 34.

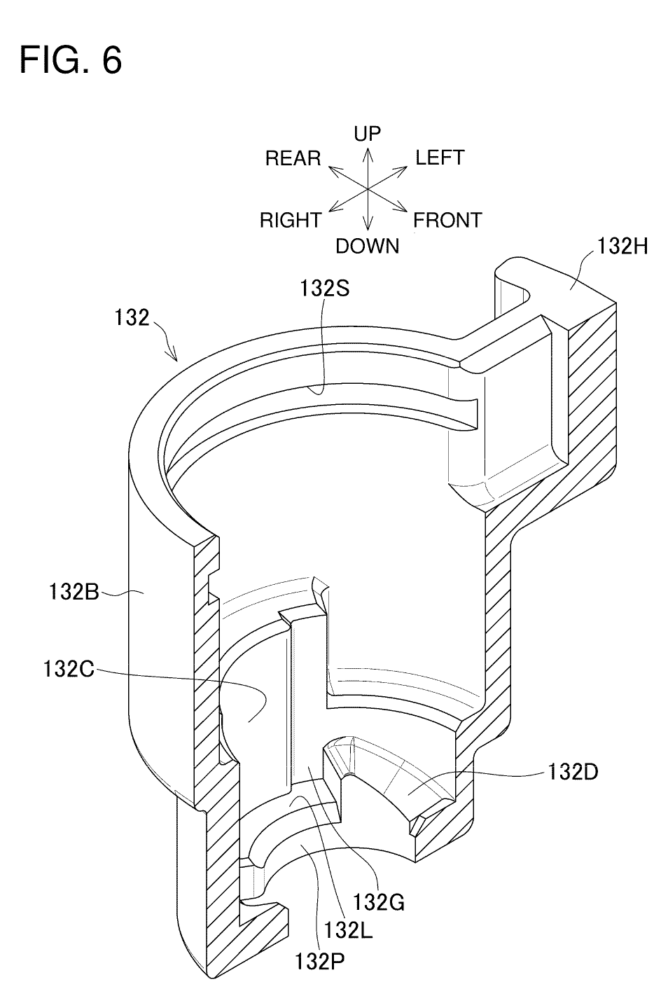

As also shown in FIG. 6, the sleeve 132 is a cylindrical cap. The sleeve 132 includes a sleeve body 132B, a handle 132H, a circlip receiving groove 132S, a first cam surface 132C as a cam surface, a blade through-hole 132P, multiple (two) blade holding portions 132L, an engaging portion guide 132G as a receiving portion, and a second cam surface 132D. The directions indicated in FIG. 6 are for when the blade is locked.

The sleeve body 132B is a cap including a cylindrical portion extending vertically and a lower surface portion.

The handle 132H is a lever protruding radially outward from a left portion of the sleeve body 132B.

The circlip receiving groove 132S is located on the inner surface of an upper opening in the sleeve body 132B. The circlip receiving groove 132S is annular and has a break. The break is located at a basal end of the handle 132H. The circlip receiving groove 132S is recessed radially outward from the adjacent inner surface.

The first cam surface 132C is a right portion of the inner surface of a lower portion of the sleeve body 132B. The first cam surface 132C is located radially outward from the first pressing member 130. The first cam surface 132C has an inner diameter gradually decreasing from the front to the rear.

The first pressing member 130 is located radially inward from the first cam surface 132C. The first pressing member head 130H has a radially outward surface, or in other words, a right surface that comes in contact with the first cam surface 132C. The first pressing member 130 can move along the first cam surface 132C through rotational movement relative to the sleeve 132.

The blade through-hole 132P is located in the lower surface portion of the sleeve body 132B. The blade through-hole 132P has the shape of φ. The blade through-hole 132P has, in its circular portion as viewed from bottom to top, a diameter that is the same as or slightly greater than the dimension of a portion of the upper end portion of the blade 34 without the protrusions 34C in the front-rear direction (in other words, the width direction of the blade 34). The blade through-hole 132P has, in its rectangular portion as viewed from bottom to top, long sides with a dimension that is the same as or slightly greater than the dimension of a portion of the upper end portion of the blade 34 with the protrusions 34C in the front-rear direction.

The blade holding portions 132L are arranged in the front-rear direction. Each blade holding portion 132L is located in the lower surface portion of the sleeve body 132B and adjacent to the blade through-hole 132P in. More specifically, the front blade holding portion 132L is located counterclockwise from the front end of the rectangular portion elongated radially outward from the circular portion of the blade through-hole 132P as viewed from bottom to top. The rear blade holding portion 132L is located counterclockwise from the rear end of the rectangular portion elongated radially outward from the circular portion of the blade through-hole 132P as viewed from bottom to top.

The engaging portion guide 132G is the inner surface of the left portion of the sleeve body 132B. The engaging portion guide 132G is located on the left of the first cam surface 132C. The engaging portion guide 132G is a groove with a greater inner diameter than the adjacent first cam surface 132C. The engaging portion guide 132G is located on the left of the rear blade holding portion 132L.

The second cam surface 132D is the inner surface of a left portion of the lower surface portion of the sleeve body 132B adjacent to the blade through-hole 132P. The second cam surface 132D is adjacent to the blade holding portions 132L. The second cam surface 132D is located on the left of a lower end portion of the engaging portion guide 132G. The vertical position, or specifically, the height of the second cam surface 132D varies. The second cam surface 132D has the largest height at a position closest to the engaging portion guide 132G, and has gradually smaller height toward the left front in the circumferential direction.

The first urging member 134 is an elastic member. The first urging member 134 is a torsion spring. The first urging member 134 is annular and extends in the front-rear and lateral directions. The first urging member 134 urges the sleeve 132 counterclockwise as viewed from bottom to top. The first urging member 134 urges the first pressing member 130 through the sleeve 132.

The first urging member 134 includes an upper end portion extending radially outward and held by the handle 132H in the sleeve 132.

The first urging member 134 includes a lower end portion extending vertically. The first urging member 134 is stopped by the stopper 136. To illustrate the components sufficiently clearly in the perspective views, FIGS. 4 and 5 show the first urging member 134 and the stopper 136 in contact with each other.

The stopper 136 is pin-shaped and received in the stopper receiving hole 84P in the guide 84G in the slider body 84.

The first urging member 134 is located above the first pressing member 130. The first urging member 134 may be located below the first pressing member 130. This reduces the size of the blade holder 32 in the radial direction.

The first urging member 134 is located radially inward from the sleeve 132.

The circlip 138 is located above the flange 84F on the guide 84G and held in the circlip receiving groove 132S on the sleeve 132. The circlip 138 prevents the sleeve 132 from slipping off the guide 84G.

The cover 140 is annular. The cover 140 is fitted to an upper end opening in the sleeve 132 to cover the upper end opening. The cover 140 reduces entry of dust into the sleeve 132.

The second pressing member 142 is pin-shaped and extends vertically. The second pressing member 142 includes a pressing portion 142P, a tongue 142T, and an engaging portion 142F.

The pressing portion 142P is cylindrical and extends vertically. The pressing portion 142P is located in an upper end portion of the second pressing member 142. An imaginary centerline of the pressing portion 142P extending vertically or its extension passes through the attached blade 34.

The tongue 142T is a plate having a cylindrical surface. The tongue 142T extends downward from a left portion of a lower end portion of the pressing portion 142P. The cylindrical surface of the tongue 142T is continuous with the cylindrical surface of the left portion of the pressing portion 142P. The tongue 142T is located radially inward from the first urging member 134. The space inside the blade holder 32 is thus effectively used. This allows the blade holder 32 to be more compact. The second pressing member 142 extends through the inner space of the first urging member 134. The tongue 142T connects the pressing portion 142P and the engaging portion 142F. The pressing portion 142P, the tongue 142T, and the engaging portion 142F are integral with one another. The tongue 142T extending vertically is offset from the imaginary centerline of the pressing portion 142P in the lateral direction.

The engaging portion 142F is a plate and extends vertically and laterally. The engaging portion 142F protrudes leftward from the left surface of a lower end portion of the tongue 142T.

The pressing portion 142P and the tongue 142T are received in the blade receiving groove 84C on the guide 84G in a vertically movable manner. The pressing portion 142P and the tongue 142T have semicylindrical left surfaces continuous with each other. The left surfaces of the pressing portion 142P and the tongue 142T are located along and in contact with the semicylindrical left inner surface of the blade receiving groove 84C. The pressing portion 142P and the tongue 142T move as guided by the blade receiving groove 84C. The engaging portion 142F is received in the engaging portion guide slit 84S in the guide 84G in a vertically movable manner. The engaging portion 142F moves vertically as guided by the engaging portion guide slit 84S. The engaging portion 142F is received in the engaging portion guide 132G in the sleeve 132 in a vertically movable manner. The engaging portion 142F moves vertically as partially guided by the engaging portion guide 132G.

The second pressing member 142 can press the blade 34.

The second urging member 144 is an elastic member. The second urging member 144 is a compression spring. The second urging member 144 extends vertically. The second urging member 144 urges the second pressing member 142 downward.

The second urging member 144 is located above the second pressing member 142. The second urging member 144 is received in an upper end portion of the blade receiving groove 84C.

The blade holder 32 is joined to the guide 84G in the slider body 84 in the manner described below. Although the joining operation is performed in the directions shown in the figures for ease of understanding, the actual joining operation may be performed with various components oriented in directions different from the directions described below.

The second urging member 144 and the second pressing member 142 are placed in the blade receiving groove 84C. The circlip 138 is placed above the flange 84F. The first pressing member 130 is placed in the guide hole 84H. The stopper 136 is placed in the stopper receiving hole 84P not to protrude radially outward.

With the upper end portion of the first urging member 134 attached to the handle 132H in the sleeve 132, the sleeve 132 is relatively moved radially outward from the lower end of the guide 84G. The circlip 138 is received in the circlip receiving groove 132S. The engaging portion 142F in the second pressing member 142 is received in the engaging portion guide 132G in the sleeve 132. The sleeve 132 is then moved to cause a radially outward end of the stopper 136 to protrude radially outward from the stopper receiving hole 84P, causing the lower end of the first urging member 134 to be hooked on the stopper 136.

Finally, the cover 140 is fitted to the upper opening in the sleeve 132.

The blade holder 32 allows automatic attachment of the blade 34 in a tool-less manner with a single operation when the blade 34 is simply received between the first pressing member 130 and the second pressing member 142.

Attaching the blade 34 will now be described sequentially using the states of the blade 34 before insertion, during insertion, during pushing, and being locked. The above four states are distinguished for ease of explanation. The actual attachment of the blade 34 is performed in a series of operations in a short time.

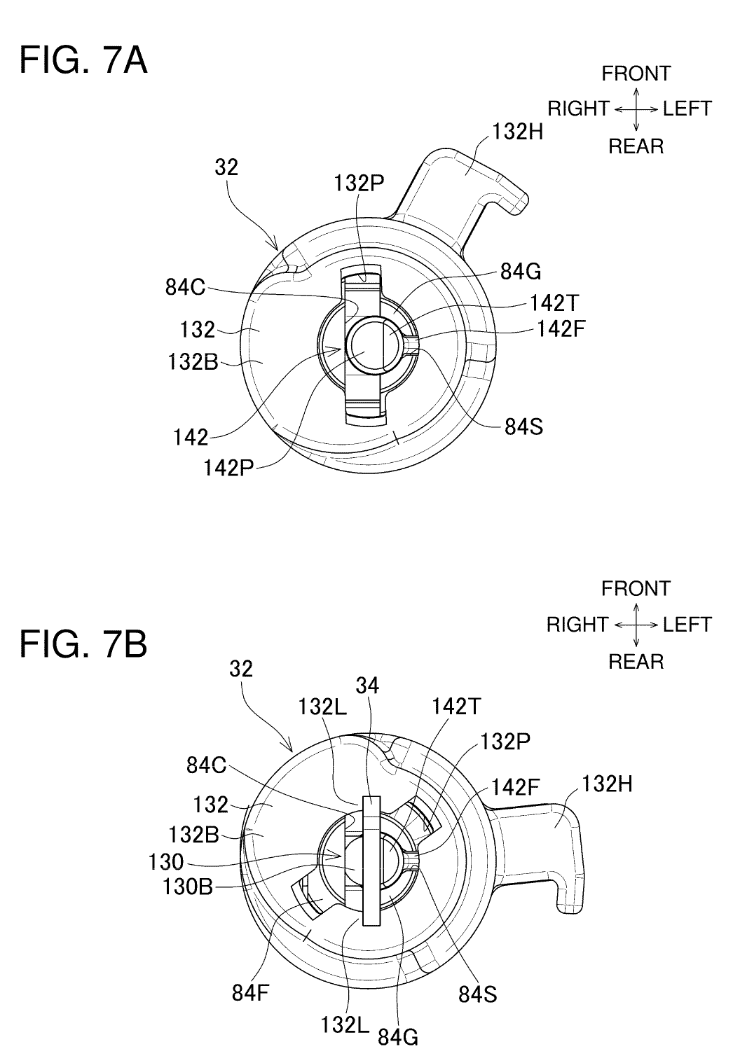

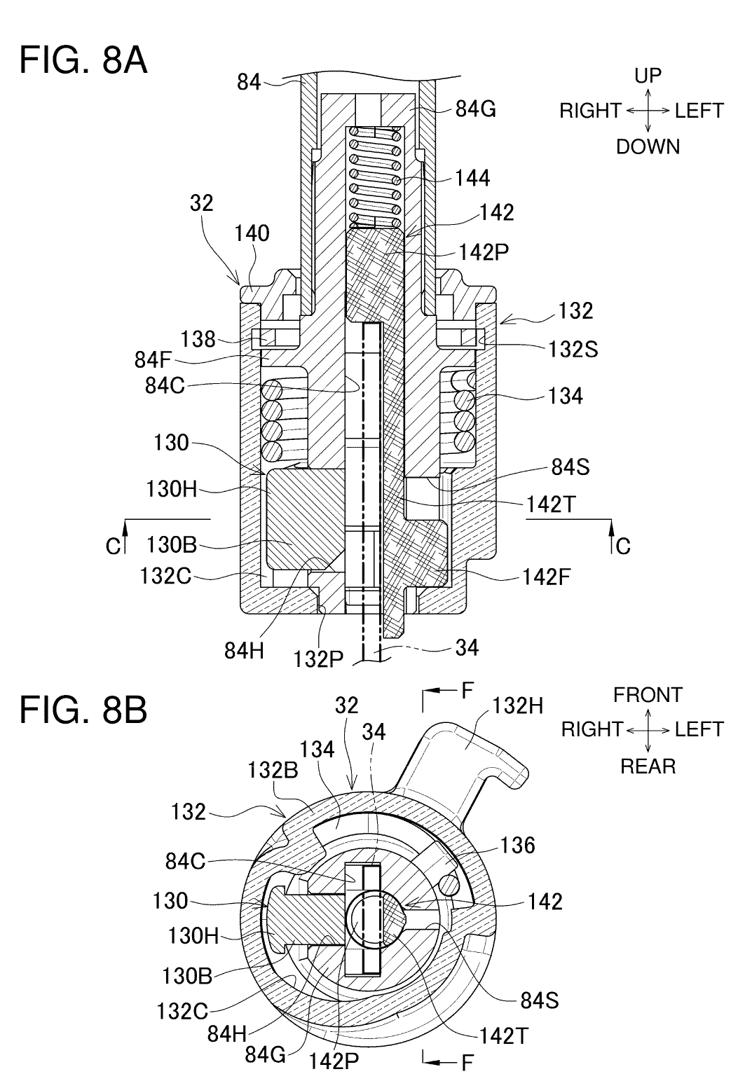

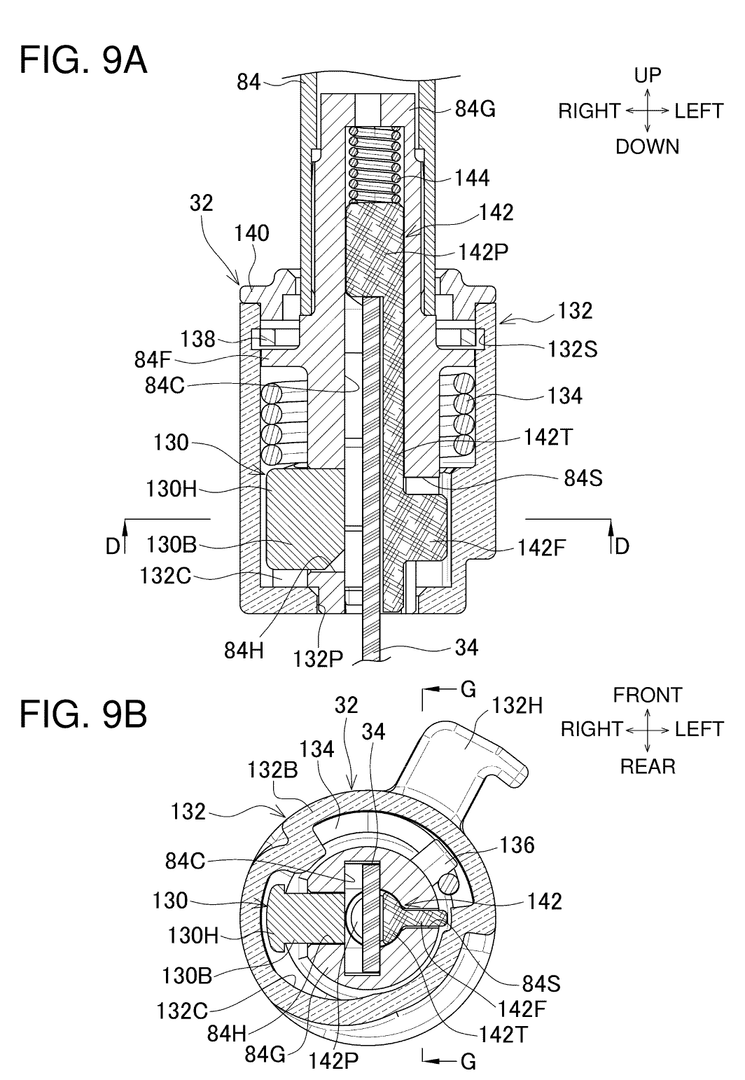

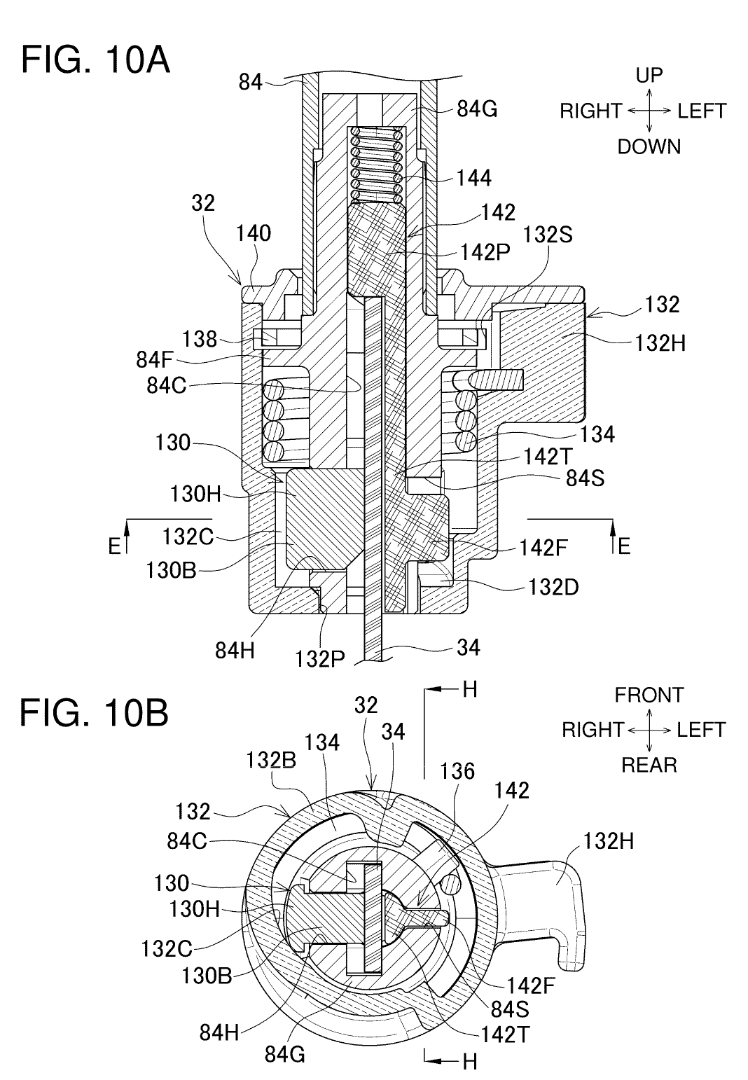

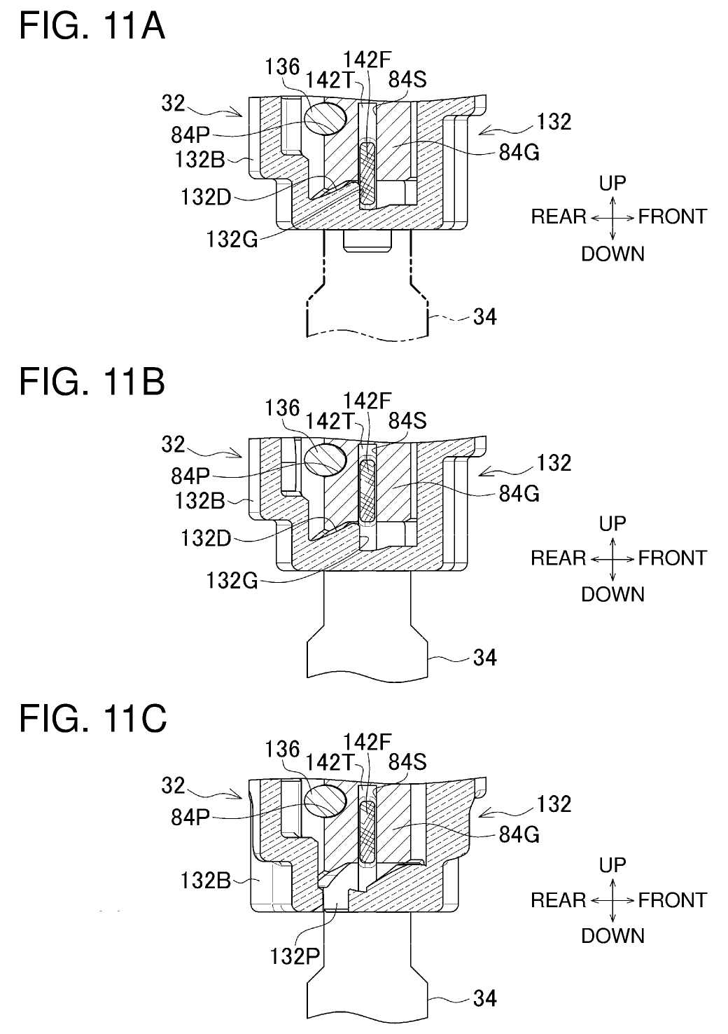

FIG. 7A is a bottom view of the blade holder 32 before insertion of the blade 34. FIG. 7B is a bottom view of the blade holder 32 with the blade 34 being locked. FIG. 8A is a sectional view of the blade holder 32 taken along line A-A before and during insertion of the blade 34. FIG. 8B is a sectional view taken along line C-C in FIG. 8A. FIG. 9A is a sectional view of the blade holder 32 taken along line A-A during pushing of the blade 34. FIG. 9B is a sectional view taken along line D-D in FIG. 9A. FIG. 10A is a sectional view of the blade holder 32 taken along line A-A when the blade 34 is locked. FIG. 10B is a sectional view taken along line E-E in FIG. 10A. FIG. 11A is a sectional view taken along line F-F in FIG. 8B. FIG. 11B is a sectional view taken along line G-G in FIG. 9B. FIG. 11C is a sectional view taken along line H-H in FIG. 10B.

The rectangular portion of the blade through-hole 132P in the sleeve 132 faces in the front-rear direction before insertion of the blade 34. The handle 132H is located frontward and slightly leftward (at the one o'clock position in FIGS. 7A and 8B).

The first urging member 134 urges the sleeve 132 clockwise as viewed from bottom to top (FIG. 8B). The second urging member 144 has an equilibrium length or a length closer to the equilibrium length.

Further, the engaging portion 142F of the second pressing member 142 is received in the engaging portion guide 132G. This restricts the sleeve 132, which is under an urging force from the first urging member 134, from rotating clockwise. In other words, the sleeve 132 is locked in a nonrotatable manner. The engaging portion 142F includes a lower edge portion in contact with the inner surface of a lower surface portion of the sleeve 132. The second pressing member 142 is thus prevented from slipping off.

The engaging portion 142F is received in and engaged with the engaging portion guide 132G to stop the rotation of the sleeve 132. With the compactness of the blade holder 32 maintained, this structure can stop the rotation of the sleeve 132.

The first pressing member 130 is located radially inward from a larger-diameter portion of the first cam surface 132C. The first pressing member body 130B can easily move rightward and easily retract from the blade receiving groove 84C.

In this state, the end of the blade 34 adjacent to the protrusions 34C to be inserted into the blade holder 32 first passes through the rectangular portion of the blade through-hole 132P. The blade 34 is thus guided to be in an orientation for attachment in which the blade 34 extends in the front-rear and vertical directions.

The end of the blade 34 then passes between the first pressing member 130 and the second pressing member 142.

The end of the blade 34 then comes in contact with the lower surface of the pressing portion 142P of the second pressing member 142 (the two-dot-dash lines in FIGS. 8A, 8B, and 11A).

The tool opener 35 is not operated during insertion of the blade 34 as described above and during pushing of the blade 34 as described below. The tool opener 35 is used in detaching the blade 34.

The blade 34 is further moved upward and pushes the second pressing member 142. This corresponds to pushing of the blade 34.

The pressing portion 142P is pushed upward by the end of the blade 34 against an urging force from the second urging member 144. The left surfaces of the pressing portion 142P and the tongue 142T are guided by the left surface of the blade receiving groove 84C. The engaging portion 142F is guided by the engaging portion guide slit 84S and the engaging portion guide 132G. Each protrusion 34C on the blade 34 is guided by the corresponding slit in the blade receiving groove 84C.

The lower edge portion of the engaging portion 142F then reaches a position upper than an upper edge portion of the engaging portion guide 132G in the sleeve 132. The engaging portion 142F thus moves out of the engaging portion guide 132G and is disengaged from the engaging portion guide 132G. The sleeve 132 then automatically rotates, under the urging force from the first urging member 134, clockwise as viewed from bottom to top.

The sleeve 132 stops rotating when the first pressing member 130 enters a predetermined state. More specifically, the sleeve 132 stops rotating when the first pressing member head 130H comes in contact with the first cam surface 132C of the sleeve 132 and the first pressing member body 130B presses, with its left surface, the right surface of the blade 34. The first pressing member 130 moves leftward along the first cam surface 132C during the rotation of the sleeve 132. The first pressing member 130 is urged by the first urging member 134 through the sleeve 132 after the rotation of the sleeve 132. More specifically, the first cam surface 132C converts the clockwise urging force of the first pressing member 130 as viewed from bottom to top to a leftward urging force applied to the first pressing member 130. With no blade 34 being inserted, the first urging member 134 is contracted with its arm rotated by 50° from its free angle. When the blade 34 is inserted, the first urging member 134 is contracted with its arm rotated by 60° from its free angle. The first pressing member 130 automatically presses the blade 34 in response to the second pressing member 142 being pushed upward. The angle by which the first urging member 134 is rotated from its free angle in each state may be changed variously from the above values.

In the above state, the rectangular portion of the blade through-hole 132P faces in an oblique direction from the right rear to the left front as viewed from bottom to top. The protrusions 34C on the blade 34 are located above the lower surface portion of the sleeve body 132B. The lower edge of each protrusion 34C is in contact with the corresponding blade holding portion 132L. Each protrusion 34C is urged toward the corresponding blade holding portion 132L by the second urging member 144. The upper edge of each protrusion 34C is spaced from the upper end of the corresponding slit in the blade receiving groove 84C. The handle 132H is located leftward (at the three o'clock position in FIGS. 7B and 10B).

Upon completion of the rotation of the sleeve 132, the blade 34 is locked in the blade holder 32.

When the blade 34 is locked, the blade 34 is held between the first pressing member 130 and the left inner surface of the blade receiving groove 84C as shown in FIG. 10B. A middle portion of the right surface of the blade 34 in the front-rear direction is in contact with the left end surface of the first pressing member 130. A front portion and a rear portion of the left surface of the blade 34 are in contact with the left inner surface of the blade receiving groove 84C. Each protrusion 34C on the blade 34 is held on the corresponding blade holding portion 132L in the sleeve 132. The blade 34 is thus prevented from slipping off.

The blade 34 attached to the blade holder 32 has an imaginary centerline extending in a direction in which the blade 34 extends, or more specifically, the vertical direction. The blade holder 32 has an imaginary centerline extending in a direction in which the blade holder 32 extends, or more specifically, the vertical direction. The imaginary centerline of the blade 34 attached to the blade holder 32 is offset from the imaginary centerline of the blade holder 32 toward the first pressing member 130 in a direction perpendicular to a direction of reciprocation, or more specifically, the lateral direction. The blade 34 is offset rightward from the center of blade holder 32. This allows the blade holder 32 to accommodate various thicknesses of the blade 34.

The blade 34 is detached in the manner described below.

When a left portion of the tool opener 35 is moved forward with the power supply of the jigsaw 1 being off, a left rear portion of the tool opener 35 moves the handle 132H in the sleeve 132 against the urging force from the first urging member 134.

The sleeve 132 then rotates counterclockwise as viewed from bottom to top. The sleeve 132 in the state in FIG. 7B thus enters the state in FIG. 7A. The engaging portion 142F of the second pressing member 142 relatively moves along the second cam surface 132D under the downward urging force from the second urging member 144 during the rotation of the sleeve 132. At the end of the rotation of the sleeve 132, the engaging portion 142F is received in the engaging portion guide 132G from an end of the second cam surface 132D to stop the rotation of the sleeve 132.

The larger-diameter portion of the first cam surface 132C is located on the right of the first pressing member 130. The first pressing member 130 can freely move rightward oppositely to the blade 34, without receiving the urging force from the first urging member 134. The direction in which the rectangular portion of the blade through-hole 132P faces changes from the oblique direction to the front-rear direction. The rectangular portion of the blade through-hole 132P is at a rotational position at which the protrusions 34C on the blade 34 can pass through the rectangular portion of the blade through-hole 132P. Each protrusion 34C is moved away from the corresponding blade holding portion 132L by rotation of sleeve 132. The blade 34 is thus pushed downward under the urging force from the second urging member 144 through the second pressing member 142.

In the blade holder 32, the first urging member 134 is displaced from the first pressing member 130 in the vertical direction and located above the first pressing member 130. More specifically, the movable first urging member 134 does not overlap the first pressing member 130 as viewed in a direction perpendicular to the direction in which the slider body 84 extends (the radial direction of the sleeve 132), independently of the position of the first urging member 134. In other words, the movable first urging member 134 does not overlap the first pressing member 130 as viewed in the moving direction of the first pressing member 130 (specifically, the lateral direction), independently of the position of the first urging member 134. More specifically, the first urging member 134 is located to avoid being in the moving direction of the first pressing member 130.

The jigsaw 1 with this structure can reduce the size of the first urging member 134 in at least one of the front-rear direction or the lateral direction, or more specifically, the size of the first urging member 134 in the front-rear and lateral directions, thus optimizing the size of the first urging member 134. This structure reduces the size of the blade holder 32 in the front-rear and lateral directions, allowing the blade holder 32 to have a smaller diameter. This improves the viewability of an area around the blade 34, thus improving the workability of the jigsaw 1 in cutting or other operations.

With the urging force from the first urging member 134 and the urging force from the second urging member 144 in the jigsaw 1, the user can easily attach the blade 34 by simply inserting the blade 34 into the blade holder 32 without operating the tool opener 35. The user can easily detach the attached blade 34 by simply operating the tool opener 35 to move the handle 132H forward.

In the blade holder 32, the blade 34 is held mainly between the first pressing member 130 and the second pressing member 142. The upper edge of each protrusion 34C is spaced from the upper end of the corresponding slit in the blade receiving groove 84C.

This reduces wear on the upper edges and the lower edges of the protrusions 34C. This reduces the likelihood of a change in the angle at which the blade 34 is attached, thus reducing the likelihood that the workability is affected.

An operation example of the jigsaw 1 will now be described.

The user attaches the blade 34 to the blade holder 32. The user can attach the blade 34 to the blade holder 32 by simply placing the upper end portion of the blade 34 into the blade holder 32 and, finally, pushing the blade 34 slightly.

The user attaches the charged battery 8 to the battery mount 18.

When the user operates the on-off switches 26 within the predetermined time after operating the lock-off switches 27, the controller 20 supplies power from the battery 8 to the electric motor 12 under control to rotate the motor shaft 53 at a controlled speed. The electric motor 12 is driven at a speed corresponding to the rotational position of the speed adjustment switch 22.

The rotational direction of the motor shaft 53 may be switchable.

As the motor shaft 53 rotates, the fan 14 rotates to produce, in the body 2, an airflow (or specifically, wind) flowing outward in the radial direction of the fan 14 from the inlets 44 and gaps in the housing 10.

This cools the internal components of the jigsaw 1 including the electric motor 12 and the controller 20.

The rotational force of the motor shaft 53 is converted to reciprocating motion through deceleration at the intermediate gear 65 and transmitted to the slider 29, the blade holder 32, and the blade 34.

The counterweight unit 38 reduces vibrations of the jigsaw 1.

The user switches the mode of the orbital action of the blade 34 by operating the knob 37K as appropriate.

The user adjusts the speed of the reciprocation of the blade 34 with the speed adjustment switch 22.

The user places the workpiece-acting part of the reciprocating blade 34 onto a target portion of a workpiece, and moves the blade 34 relative to the workpiece. The target portion of the workpiece is then cut with the blade 34.

When the processing is complete, the user operates the on-off switches 26 to turn off the electric motor 12. The blade 34 then stops. The user detaches the battery 8 and the blade 34 as appropriate.

The user can detach the blade in a tool-less manner with a single operation by operating the tool opener 35.

The above embodiment and its modifications are not limited to the structures described above, and may be modified as appropriate as, for example, described below.

In the jigsaw 1, the first pressing member 130 may not automatically press the blade 34 when the second pressing member 142 is pushed by the blade 34. For example, the blade 34 may be attachable by the user maintaining the operation to move the tool opener 35 forward.

The rotation transmitted from the motor shaft 53 to the blade 34 in the jigsaw 1 may be reduced by a reducer other than the pinion 54 and the intermediate gear 65. The rotational driving force transmitted from the motor shaft 53 to the blade 34 in the jigsaw 1 may be converted to a reciprocating motion by a reciprocation converter other than the guide roller unit 69 and the roller guide 80.

The jigsaw 1 may include a power cord in place of the battery mount 18 to be AC powered with utility power. At least one of the cases or housings may be formed from a material such as resin, metal, or a composite of these materials. The housing 10 may be dividable differently from the manner described above. In addition, for example, at least one of the number, material, arrangement, structure, or type of any components or portions may be modified as appropriate.

Further, the above embodiment or its modifications may be applied to a jigsaw to which a tip tool other than the blade 34 is attached.

Additionally, the above embodiment or its modifications may be applied to a reciprocating cutting tool other than a jigsaw such as a reciprocating saw.

### Reference Signs List

1 jigsaw

32 blade holder

34 blade

130 first pressing member

132 sleeve

132C first cam surface (cam surface)

132G engaging portion guide (receiving portion)

134 first urging member

142 second pressing member

142F engaging portion

142P pressing portion

142T tongue

144 second urging member

What is claimed is:

1. A reciprocating cutting tool, comprising:
a blade attachment to which a blade is detachably attachable, the blade attachment being reciprocable, the blade attachment including
a first pressing member movable toward or away from the blade to press the blade,
a first urging member configured to urge the first pressing member,
a second pressing member configured to press the blade in a direction different from a direction in which the first pressing member presses the blade, and
a second urging member configured to urge the second pressing member,
wherein the first pressing member automatically presses the blade when the second pressing member is pushed by the blade, and
the first urging member is located to avoid being in a moving direction of the first pressing member.

2. The reciprocating cutting tool according to claim 1, wherein
the second pressing member is movable in a direction in which the blade attachment is reciprocable,
the first pressing member is movable in a direction perpendicular to a moving direction of the second pressing member, and
the first urging member is displaced from the first pressing member in the direction in which the blade attachment is reciprocable.

3. The reciprocating cutting tool according to claim 1, wherein
the first urging member is a torsion spring, and
the second pressing member is located radially inward from the first urging member.

4. The reciprocating cutting tool according to claim 1, wherein
the blade attachment includes a sleeve rotatable about a direction in which the blade attachment is reciprocable, and
the first pressing member and the first urging member are located radially inward from the sleeve.

5. The reciprocating cutting tool according to claim 4, wherein
the sleeve has an inner surface including a cam surface, and
the first pressing member moves along the cam surface to move in response to rotation of the sleeve.

6. The reciprocating cutting tool according to claim 4, wherein
the second pressing member extends in the direction in which the blade attachment is reciprocable,
the second pressing member includes an engaging portion,
the sleeve includes a receiving portion, and
the engaging portion engages with the receiving portion to stop rotation of the sleeve.

7. The reciprocating cutting tool according to claim 6, wherein
when the engaging portion is engaged with the receiving portion, the sleeve allows the first pressing member to move to a position at which the first pressing member does not press the blade, and
when the engaging portion is disengaged from the receiving portion, the sleeve causes the first pressing member to move to a position at which the first pressing member presses the blade.

8. The reciprocating cutting tool according to claim 6, wherein
the second pressing member includes
a pressing portion, and
a tongue integrally connecting the engaging portion and the pressing portion, and
when the pressing portion is pushed by the blade, the engaging portion moves out of the receiving portion.

9. The reciprocating cutting tool according to claim 8, wherein
the tongue and the pressing portion extend in a direction in which the blade attachment is reciprocable, and
the tongue is offset from an imaginary centerline of the pressing portion in a direction perpendicular to the direction in which the blade attachment is reciprocable.

10. A reciprocating cutting tool, comprising:
a blade attachment to which a blade is detachably attachable, the blade attachment being reciprocable, the blade attachment including
a sleeve rotatable about a direction in which the blade attachment is reciprocable, the sleeve including a receiving portion,
a first pressing member located radially inward from the sleeve and movable in response to rotation of the sleeve, the first pressing member being movable toward or away from the blade to press the blade,
a first urging member located radially inward from the sleeve, the first urging member being configured to urge the first pressing member,
a second pressing member configured to press the blade in the direction in which the blade attachment is reciprocable, the second pressing member including
an engaging portion engageable with the receiving portion to stop rotation of the sleeve,
a pressing portion extending in the direction in which the blade attachment is reciprocable, and
a tongue integrally connecting the engaging portion and the pressing portion and extending in the direction in which the blade attachment is reciprocable, the tongue being offset from an imaginary centerline of the pressing portion in a direction perpendicular to the direction in which the blade attachment is reciprocable, and
a second urging member configured to urge the second pressing member,
wherein, when the pressing portion is pushed by the blade, the engaging portion moves out of the receiving portion.

11. The reciprocating cutting tool according to claim 1, wherein
the blade attached to the blade attachment has an imaginary centerline extending in a direction in which the blade extends, the blade attachment has an imaginary centerline extending in a direction in which the blade attachment extends, and the imaginary centerline of the blade attached to the blade attachment is offset from the imaginary centerline of the blade attachment toward the first pressing member in a direction perpendicular to the direction in which the blade attachment is reciprocable.

12. The reciprocating cutting tool according to claim 2, wherein
the first urging member is a torsion spring, and
the second pressing member is located radially inward from the first urging member.

13. The reciprocating cutting tool according to claim 2, wherein
the blade attachment includes a sleeve rotatable about a direction in which the blade attachment is reciprocable, and
the first pressing member and the first urging member are located radially inward from the sleeve.

14. The reciprocating cutting tool according to claim 3, wherein
the blade attachment includes a sleeve rotatable about a direction in which the blade attachment is reciprocable, and
the first pressing member and the first urging member are located radially inward from the sleeve.

15. The reciprocating cutting tool according to claim 5, wherein
the second pressing member extends in the direction in which the blade attachment is reciprocable,
the second pressing member includes an engaging portion,
the sleeve includes a receiving portion, and
the engaging portion engages with the receiving portion to stop rotation of the sleeve.

16. The reciprocating cutting tool according to claim 7, wherein
the second pressing member includes
a pressing portion, and
a tongue integrally connecting the engaging portion and the pressing portion, and
when the pressing portion is pushed by the blade, the engaging portion moves out of the receiving portion.

17. The reciprocating cutting tool according to claim 2, wherein
the blade attached to the blade attachment has an imaginary centerline extending in a direction in which the blade extends, the blade attachment has an imaginary centerline extending in a direction in which the blade attachment extends, and the imaginary centerline of the blade attached to the blade attachment is offset from the imaginary centerline of the blade attachment toward the first pressing member in a direction perpendicular to the direction in which the blade attachment is reciprocable.

18. The reciprocating cutting tool according to claim 3, wherein
the blade attached to the blade attachment has an imaginary centerline extending in a direction in which the blade extends, the blade attachment has an imaginary centerline extending in a direction in which the blade attachment extends, and the imaginary centerline of the blade attached to the blade attachment is offset from the imaginary centerline of the blade attachment toward the first pressing member in a direction perpendicular to the direction in which the blade attachment is reciprocable.

19. The reciprocating cutting tool according to claim 4, wherein
the blade attached to the blade attachment has an imaginary centerline extending in a direction in which the blade extends, the blade attachment has an imaginary centerline extending in a direction in which the blade attachment extends, and the imaginary centerline of the blade attached to the blade attachment is offset from the imaginary centerline of the blade attachment toward the first pressing member in a direction perpendicular to the direction in which the blade attachment is reciprocable.

20. The reciprocating cutting tool according to claim 5, wherein
the blade attached to the blade attachment has an imaginary centerline extending in a direction in which the blade extends, the blade attachment has an imaginary centerline extending in a direction in which the blade attachment extends, and the imaginary centerline of the blade attached to the blade attachment is offset from the imaginary centerline of the blade attachment toward the first pressing member in a direction perpendicular to the direction in which the blade attachment is reciprocable.
